(19) United States
(12) Patent Application Publication
(10) Pub. No.: US 2014/0136468 A1
(43) Pub. Date: May 15, 2014

(54) QUANTITATIVE ASSESSMENT OF SIMILARITY OF CATEGORIZED DATA

(71) Applicant: Robust Links, LLC, New York, NY (US)

(72) Inventors: Peyman Faratin, New York, NY (US); Fabian Menges, New York, NY (US)

(21) Appl. No.: 14/079,252

(22) Filed: Nov. 13, 2013

Related U.S. Application Data
(60) Provisional application No. 61/726,055, filed on Nov. 14, 2012.

(51) Int. Cl. G06F 17/30; G06N 5/02

(52) U.S. Cl. CPC G06F 17/30625; G06N 5/022
USPC 706/55

(57) ABSTRACT

A system having a processor is programmed to realize practical quantitative assessment of similarity of categorized data. The category data may be stored in a memory as a category graph comprising a graphical data structure having plural parent and child category nodes connected by directed edges, such that sequences of connected category nodes represent hierarchical relations between categories of objects. A similarity metric of a selected pair of categories may be derived, in one embodiment, by analysis of ancestors of the selected pair of categories, including consideration of closest common ancestors in the category graph. Efficiency improvements may include transforming a directed cyclic graph to a directed acyclic graph, and optionally deriving a subgraph to reduce the number of categories under consideration. The software methods may further comprise computing a similarity metric for a pair of objects based on the similarity score for the corresponding pair of categories.

### RELATED APPLICATIONS

This application claims priority to U.S. Provisional application No. 61/726,055 filed Nov. 14, 2012 and incorporated herein by this reference.

### COPYRIGHT NOTICE

© 2012-2013 Robust Links, LLC. A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever. 37 CFR §1.71(d).

### TECHNICAL FIELD

This disclosure pertains to quantitative assessment of similarity of categorized data within the field of information retrieval and artificial intelligence.

### BACKGROUND OF THE INVENTION

Categorization is a very useful organizing principle, especially as unstructured information becomes increasingly abundant. Costs invested in organizing information return incommensurate benefits to the organizer. The Internet contains many examples. Ecommerce platforms such as Ebay and Amazon, for example, describe and categorize the products and/or services that they offer. Content sites, such as Wikipedia, organize articles into various categories that have topical information. Music and videos are categorized into genre, country of origin and other metrics. Application stores like Apple's App Store and Google's Play Store contain categorized applications, books and other content.

In general, an application may be characterized as a set of discrete objects. In an embodiment an object may be text, video, images, music, graphics, and other similar objects. Given a set of objects the goal is to compute the similarity of any two given objects.

Often this characterization is done as part of a knowledge engineering exercise where categories are defined according to some desiderata and domain objects are assigned membership to one or more of these categories. Presence of categories enables measuring how similar any pair of objects are given their categories. This last (measurement) goal is the focus of our innovation—given a categorization system and objects that are members of those categories our innovation rationally determines the similarity of any arbitrary pair of objects given their categories. If the categorization system has been designed and executed on a finite and well-behaved domain then the task of defining similarity between categories can be done with little or no cost as part of the knowledge engineering. However, defining category similarity metrics in most real world applications is very costly because in dynamic and evolving information domains, such as the Internet, categorization systems are not well behaved, meaning relationships between the categories themselves do not necessarily obey any rational design (involving cycles, intransitivity for instance) and objects may belong to one or more contracting categories thereby requiring comparing similarity of multiple, possibly conflicting categories. Categorization under such circumstances is often very granular, noisy, error-prone, incomplete and/or human-generated. Consequently it is hard to provide a quantitative answer to how similar any pair of objects are given their categories.

Thus the need remains for improvements in systems, methods and software directed to quantitative assessment of similarity of categorized data that is incomplete, inconsistent and non-stationary (changing).

### SUMMARY OF THE EXEMPLARY EMBODIMENTS

The following is a summary of some exemplary embodiments in order to provide a basic understanding of some aspects of the invention. This summary is not intended to identify key/critical elements of the invention or to delineate the scope of the invention. Its sole purpose is to present some concepts of the invention in a simplified form as a prelude to the more detailed description that is presented later.

A need exists for a low-cost solution of defining category similarity metrics in most real world applications, where the categories include dynamic and evolving information domains, such as the Internet. In addition, the solution needs to be able to deal with very granular, noisy, error-prone, incomplete and/or human-generated objects and categories. It will become apparent to those skilled in the art after reading the detailed description of the present invention that the embodiments of the present invention satisfy the above mentioned needs.

This disclosure describes methods, apparatus, and computer software products for determining the similarity between a pair of objects. This is achieved using a compositional strategy—the similarity of any pair of objects is a function of the weighted linear pair wise combination of similarity of the union of all the categories of the two objects. Therefore the fundamental unit of measurement is the similarity between any pair of categories.

Categories themselves are only assumed to have some relationship with one another, and represented within a category graph. The category graph may contain cycles or comprise a tree-based graphical data structure having multiple parent and child category nodes connected by directed edges. The sequences of connected category nodes may represent hierarchical relations between categories of objects. The creation of the category graph may be produced through input of the category graph or through use of an external knowledge source, among other options of producing a tree-based graphical data structure. That is, if we are only given an object then we can use a knowledge base (such as Wikipedia) to infer the object's categories and use Wikipedia's category graph as the basis of the category comparison.

Once a category graph is produced, a pair of categories for which the similarity is desired may be selected. The pair of categories is selected to be within the representation of the category graph produced. In an embodiment, depending on the location of the pair of categories within the category graph, the category graph may be manipulated to produce a specific type of graph (a directed acyclic graph, for example) or subgraphs that are beneficial to the similarity computation.

Common ancestors of categories under consideration forms one component of the similarity measure. The ancestors of the pair of categories may be determined by accessing the category graph and traversing the category graph. The ancestors and corresponding distance to each ancestor may be stored in a data structure.

In one embodiment, ancestors of each category within the pair of categories are compared to determine common ancestors of the pair of categories. In an embodiment where no common ancestors exist, the similarity between the selected pair of categories or the selected pair of objects may be estimated to be low. In an embodiment where common ancestors exist, closest common ancestors of the pair of categories may be determined by selecting the common ancestors with the least distance to the pair of categories. Closest Common Ancestor is related to the Lowest Common Ancestor known in graph theory. While the Lowest Common Ancestor is only defined in trees, our closest common ancestor is defined for all graphs. If the category graph has a tree structure both terms, Lowest Common Ancestor and Closest Common Ancestor are synonyms.

The other component of the similarity measure is the information content of a category. For each of the selected pair of categories and the closest common ancestors, an information content is determined. In one embodiment, the information content may be assessed by summing the objects within the category and the objects within any child of the category. A similarity metric for the pair of categories may be computed based on the closest common ancestors and the information content. In a further embodiment, a pair of objects may be selected and a similarity metric for the selected pair of objects may be determined based on the similarity metric of the pair of categories.

Additional aspects and advantages of this invention will be apparent from the following detailed description of preferred embodiments, which proceeds with reference to the accompanying drawings.

### BRIEF DESCRIPTION OF THE DRAWINGS

FIG. 1 shows an exemplary directed cyclic graph of categories that may be used in connection with an embodiment of the present invention.

FIG. 2 shows an exemplary flow diagram for computing the similarity between a selected pair of categories and the optional calculation of computing the similarity metric for a selected pair of objects in accordance with one embodiment of the present invention.

FIG. 3 shows an exemplary flow diagram for identifying the closest common ancestors in accordance with one embodiment of the present invention.

FIG. 4 shows an exemplary graphical representation of deriving subgraphs from a parent graph to create a category graph in accordance with one embodiment of the present invention.

FIGS. 5A and 5B show an exemplary flow diagram for deriving subgraphs from a parent graph to create a category graph in accordance with one embodiment of the present invention.

FIG. 6 shows an exemplary high-level flow diagram of the separation of activities into pre-computation and on-demand computation processing in accordance with one embodiment of the present invention.

FIG. 7 shows an exemplary screen capture of similarity calculation results produced by one embodiment of the present invention.

FIG. 8 shows, in table format, exemplary similarity calculation data and results for two pairs of objects.

FIG. 9 shows, in table format, exemplary similarity calculation data and results for four pairs of categories.

### DETAILED DESCRIPTION OF PREFERRED EMBODIMENTS

The problem of computing the similarity between categorized objects can be solved differently depending on the structure of a category graph and the classification rules used to map objects into categories.

Objects and categories may be organized by two rules. First, the object may belong to one or more categories, where a category comprises some meta information and may group objects that share at least one common feature. Second, a category may have an unlimited number of relationships with any other category.

There are two primary ways that objects can be classified. Each object may belong to a single category and its ancestor categories. An example for this type of categorization is biological taxonomy. For example a human (object) belongs to the categories “Homo sapiens”, “Hominidae” . . . “Mammalia,” however the classification system does not allow classification of an object as both “Chimpanzee” and “Homo sapiens” at the same time, because there is no ancestral relationship between “Chimpanzee” and “Homo sapiens.”

An object may also belong to multiple categories that do not have an ancestral relationship. For example, a piece of music that contains both “Hiphop” and “Heavy Metal” elements would be a member of both categories. While “HipHop” and “Heavy Metal” may have a common ancestor “Contemporary Music” in terms of music categorization, they have no ancestral relation between one another. This classification system allows one object to be part of multiple fundamentally different categories.

Category graphs in turn can be organized as trees, forest, Directed Acyclic Graph (DAG) or Directed Cyclic Graph (DCG). The latter organization (DCG) occurs where one category (A) points to another category (B) which in turn points back to A. Examples of these types of graphs are given below, but the point to note is cycles, together with the observation above (that an object can belong to multiple categories that don't have pair wise ancestral relationships), places the strongest constraint on the similarity computation. Any solution that can solve this condition can solve other graph and object configuration.

In an embodiment, the main architecture to compute the similarity between two categorized objects may comprise the following process. A category graph describing how the categories are related to one another may be generated. All ancestors of every category in question may be found by traversing the category graph. The similarity score for each pair wise category in question may be computed using the ancestors and the information content score for each category. The similarity between the two objects may be obtained by defining a function of these local similarities. One function is the maximum similarity of all category pairs to which the two objects belong.

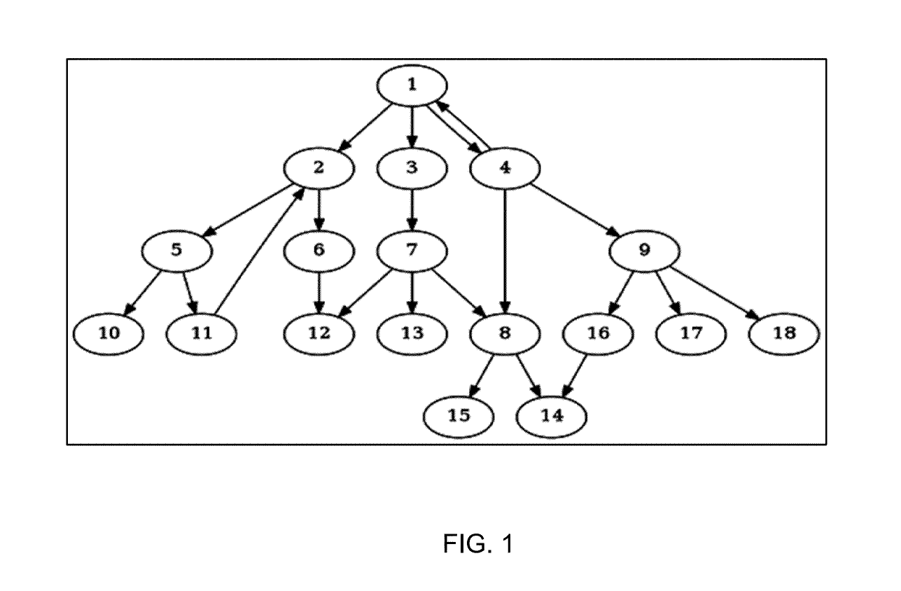

FIG. 1 shows an exemplary directed cyclic graph (DCG) that may comprise the category graph in one embodiment. Cycles in the category graph may be caused by many factors. (Nodes 5-11-2 form a cycle.) For example, one category may be a synonym of another category or the relationship between one or more categories may be erroneous. The knowledge about synonyms and erroneous category relationships may contain valuable information and may be preserved.

In another embodiment, the category graph that is used to classify objects may be a tree or a forest of trees. A tree is an undirected graph in which any two vertices are connected by exactly one simple path. Any connected graph without cycles is a tree. A forest is a disjoint union of trees. For a category graph, this has the consequence that any category can only have a single parent category.

In another embodiment, the category graph that is used to classify an object may be a directed acyclic graph (DAG). In this embodiment, any category may have multiple parent categories which do not have an ancestral relationship. For example, a “cockroach” belongs to the categories “insect” and “pest,” but there is no ancestral relationship between “pest” and “insect” since not every “insect” is a “pest” (butterfly) and not every “pest” is an “insect” (mice).

In an embodiment, no category information may be provided and we are instead given just the descriptor of an object, often as text. In this embodiment, an external knowledge source for the given object descriptor may be indexed and searched. An example of an external knowledge source is the Wikipedia encyclopedia, maintained by Wikimedia Foundation, Inc. If the object descriptor (closely or exactly) matches the title or content of a Wikipedia article, the categories of the matching Wikipedia page are retrieved and used as proxy categories for the object.

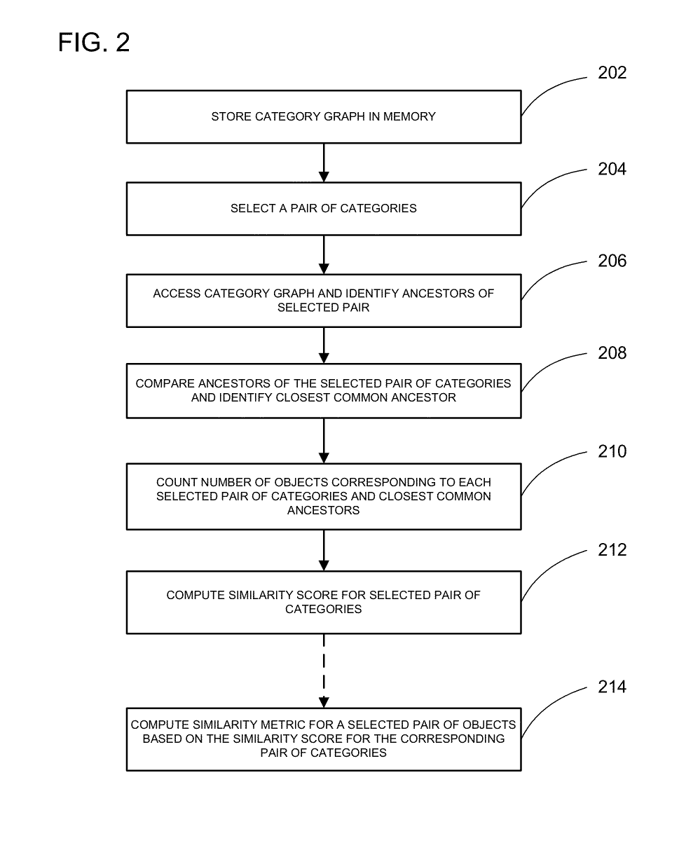

FIG. 2 shows an exemplary flow diagram for computing the similarity between a selected pair of categories and the optional calculation of computing the similarity metric for a selected pair of objects in accordance with one embodiment of the present invention. At step 202, a category graph is stored in memory. The category graph may comprise a DCG as displayed in FIG. 1, a DAG, a tree or forest of trees, or any similar graph structure. At step 204, a pair of categories of interest is selected. The pair of categories may comprise a pair of objects for which a user wants to determine the similarity between the objects. At step 206, the category graph is accessed and the category ancestors are identified for the selected pair of categories. The ancestors of the selected pair of categories may be found by traversing the category graph. Maps that contain all the ancestors and their respective distances for the selected pair of categories may be created.

At step 208, the maps of ancestors for the selected pair of categories are compared and the closest common ancestor is identified. The closest common ancestor may be identified by intersecting the maps of ancestors of each of the two categories, computing the overall distance, sorting the resulting map by distance and retrieving the ancestor with the smallest corresponding distance. There may be more than one closest common ancestor when there is an equal distance to multiple ancestors.

At step 210, the information content corresponding to each selected pair of categories and closest common ancestors are determined. One measure of information content is the cumulative sum of the total number of objects belonging to the category together with the total number of objects belonging to all sub children of the category.

In one embodiment the information content of a category c may be defined as:

$$IC ( c ) = members ( c ) + {\sum }_{s = 0}^{S ( c )} members ( s )$$

where members(x) is a function that returns the total number of objects that belong to category x and S is the total number of children nodes “below” category c in the graph.

At step 212, the similarity score for the selected pair of categories is computed. In one embodiment, the similarity of two categories i and j is then defined by the following equation:

$$sim ( i , j ) = \frac{2 * ( log ( A ) - log ( IC ( CCA ( i , j ) ) ) )}{2 * log ( A ) - log ( IC ( i ) ) - log ( IC ( j ) )}$$

where IC(x) is the information content for a category x, CCA (i,j) is the closest common ancestor between categories i and j, and A is the total number of objects.

Since objects can belong to multiple categories we must aggregate all local pair wise similarities measured above. At step 214, the final similarity metric for a selected pair of objects within the corresponding pair of categories is computed. In one embodiment, the similarity metric for a selected pair of objects (k and l) may be equal to the maximum similarity between the selected pair of categories corresponding to the objects:

sim(k,l)=argmaxi,jsim(i,j):={i,j|∀m,n:sim(m,n)<sim(i,j)}

That is, we pick, in a greedy manner, the categories with the maximum similarity to be the similarity of the pairs of objects k and l.

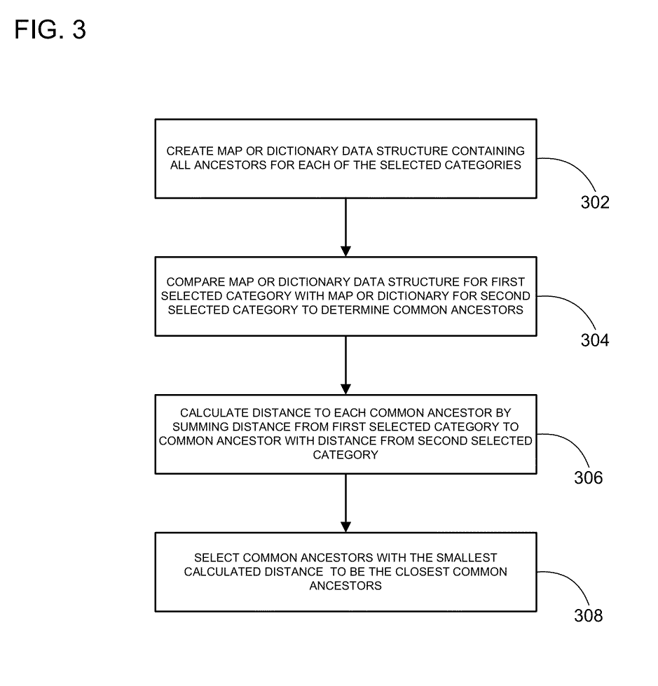

FIG. 3 shows an exemplary flow diagram for identifying the closest common ancestors in accordance with one embodiment of the present invention. At step 302, a map or dictionary data structure containing all ancestors for each of the selected categories is created. This can be implemented in a map/dictionary structure, such as a HashMap or a TreeMap. In another embodiment, the data structure may also be an associative array. The ancestors of a category may be identified by traversing the category graph upwards. Since there can be multiple paths from a source to a destination in a DAG, the data relating to the closest occurrence of each ancestor may be the only data stored in the data structure. In one embodiment, every ancestor is only visited once in order to generate the data structure.

At step 304, the data structure for the first selected category is compared with the data structure for the second selected category to determine the common ancestors between the selected pair.

At step 306, the distance to each common ancestor is calculated. The distance to each common ancestor may be determined by summing the distance from the first selected category to the ancestor with the distance from the second selected category to the ancestor. In one embodiment, if an ancestor is found multiple times, then only the minimal distance of the ancestor may be stored.

At step 308, the closest common ancestors are selected. The closest common ancestors may be selected by retrieving the ancestors where the sum of distances from each category in the pair of categories to the common ancestor is minimal.

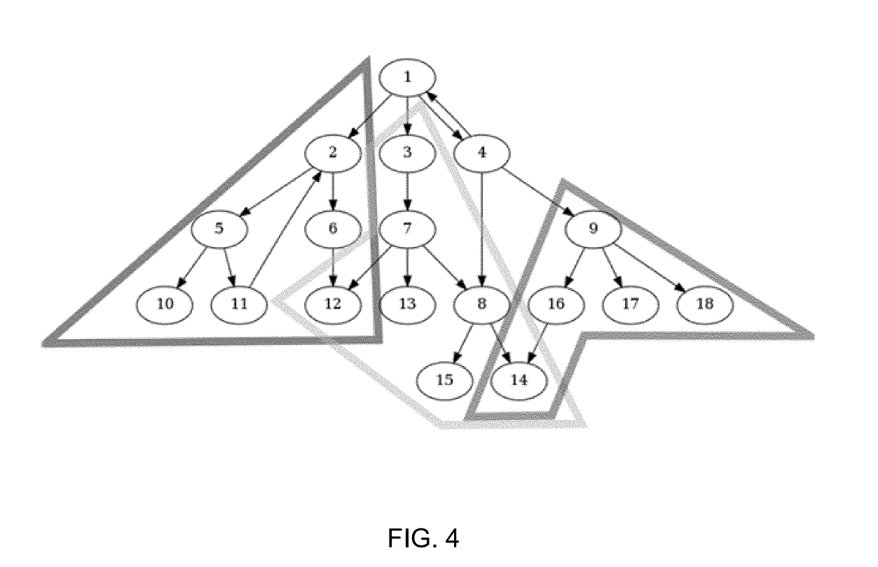

FIG. 4 shows an exemplary graphical representation of deriving subgraphs from a category graph in accordance with one embodiment of the present invention. Imagine there are hardware constraints that do not allow closest common ancestor analysis to be performed on category graphs with more than 7 nodes. Given this constraint, the goal may be to automatically detect all overlapping subgraphs with 7 nodes or less. FIG. 4 shows three overlapping subgraphs with 7 nodes or less in the category graph. All subgraphs, together, may contain all “leaf” categories. “Leaf” categories are defined as categories with no child/sub categories.

For computing the similarity of a pair of objects our method requires retrieving the closest common ancestor. However, retrieving distinct ancestors of a category in a large DCG can be computationally expensive. Reducing the size of the graph is one optimization to increase retrieval efficiency. To do so we remove all cycles in the category graph. Cycles are removed by identifying and merging strongly connected components in a graph to super-nodes. The end result of this optimization is that we transform a DCG traversal problem to a Directed Acyclic Graph (DAG) problem. Note, while super-nodes improve performance and minimize the memory requirements, some information, specifically the distance of ancestor nodes in cycles, is lost. Since the distance of ancestors does not influence the similarity score (described below), because all categories in a strongly connected component have the same number of objects associated to the given object, it is generally advantageous to merge strongly connected components.

There are several scenarios in which it is beneficial to split up the category graph and to only look at a subgraph, while still being able to calculate globally correct similarity scores. The reasons include but are not limited to:
1 Reducing the memory footprint
2 Parallelizing the graph operations

In order to be able to still calculate globally correct similarity scores that are of interest we need to define the nature of the subgraphs we are interested in. Generally, categories with low information content are of relatively more interest. Therefore our subgraphs should contain all leaves, that is categories with no child/sub categories. On the other hand, categories with high information content are usually of little interest for similarity calculations, e.g. if the CCA of two categories is the root node, their similarity will be 0.

Because we now have subgraphs (as opposed to the full graph) in order to compute the similarity between two categories we will now need to find the category subgraph that contains both categories, if there is no category subgraph that contains both then the similarity is 0. We also need to compute the Closet Common Ancestor and information content calculations on the subgraphs.

Using this method we are able to distribute the calculation of the similarity of two objects while still being able to compute globally correct scores. Specifically if we can calculate a similarity it is correct. If we cannot calculate a similarity, because no subgraph that contains both categories exists we can only estimate the similarity being low.

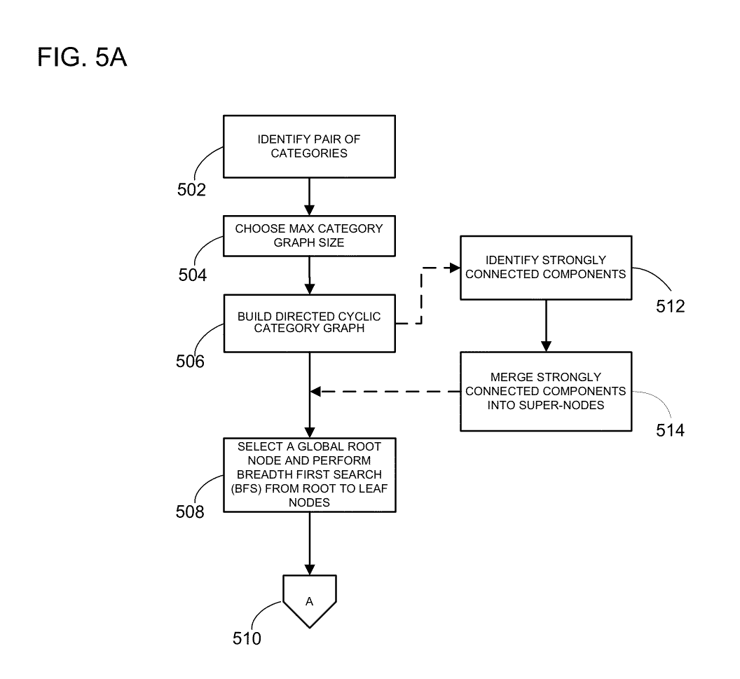

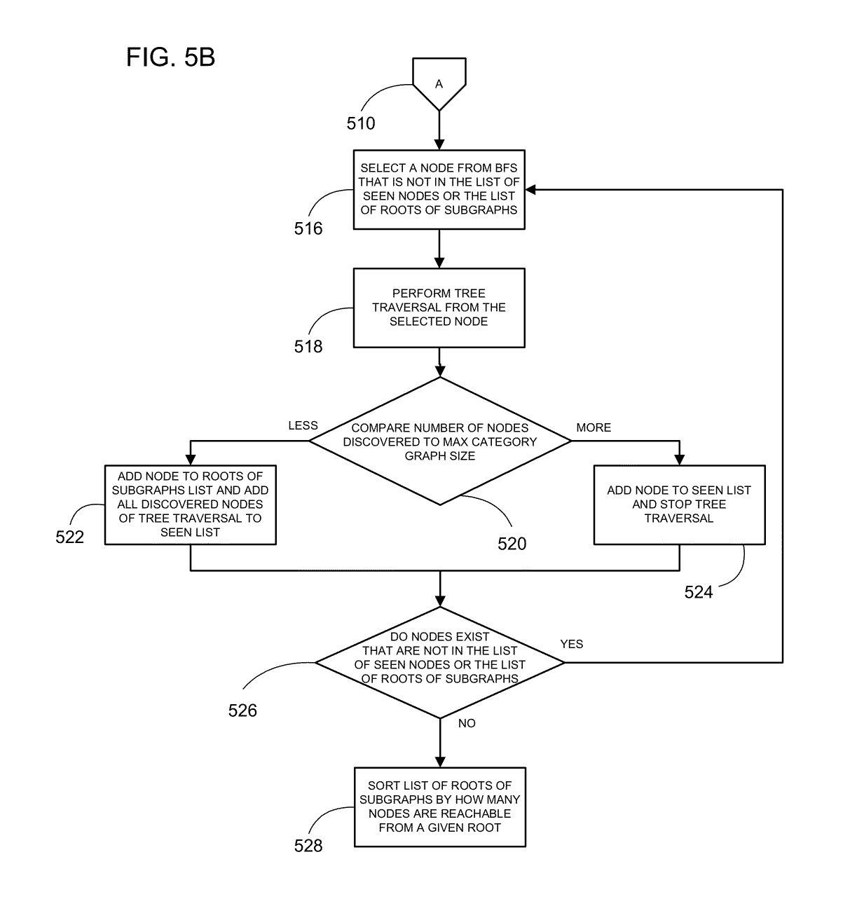

FIGS. 5A and 5B show an exemplary flow diagram for deriving subgraphs from a parent graph in accordance with one embodiment of the present invention.

At step 504, a maximum category sub graph size is chosen. The reasons that this may be beneficial comprise reducing the memory footprint and parallelizing the graph operations, among other reasons.

At step 506, a directed cyclic category graph is built. The graph may be built once, in an offline manner, and stored in memory. The category graph can be implemented using single or double linked node. The most efficient way to build the category graph may be to build it using backwards linked node, where a category has a pointer to each of its parent categories. Each category may contain the count of the cumulative number of objects that are associated to the specific category.

Because the graph may have cycles, retrieving distinct ancestors of a category in a large directed cyclic category graph can be computationally expensive. Reducing the size of the graph is one optimization to increase retrieval efficiency. To reduce the size of the graph, all cycles in the category graph are removed. Cycles are removed by identifying and merging strongly connected components in a graph to super-nodes.

Optionally, at step 512, the strongly connected components are identified. Once the strongly connected components are identified, the strongly connected components may be merged into super-nodes at step 514. The end result of these steps is that the directed cyclic category graph is transformed into a directed acyclic category graph, wherein a node may comprise a category or a super-node created from a group of strongly connected categories.

While super-nodes improve performance and minimize the memory requirements, some information, specifically the distance of ancestor nodes in cycles, may be lost. Since the distance of ancestors does not influence the similarity score because all categories in a strongly connected component have the same number of objects associated to the given object, it is generally advantageous to merge strongly connected components.

At step 508, a global root node of the subgraph is selected and a breadth first search (BFS) from the global root node to its respective “leaf” nodes is performed to identify all the nodes within the directed acyclic category graph. The global root node may be defined as the node or category within the directed acyclic category graph that does not have any ancestors.

At step 516, a node from the BFS is selected that is not in the list of seen nodes or the list of roots of subgraphs. A tree traversal is performed on the selected node in step 518 to identify the number of child nodes.

At step 520, the number of nodes discovered may be compared to the maximum category graph size. The maximum graph size is chosen exogenously to accommodate the available resources. If the number of nodes discovered is less than the maximum category graph size, the process will continue to step 522. If the number of nodes discovered is greater than the maximum category graph size, the process will continue to step 524.

At step 522, the selected node is added to the roots of subgraphs list and all nodes discovered during the tree traversal of the selected node are added to the seen list. If this step is performed, it has been determined that the selected node is the root node of a desired subgraph and the nodes discovered during the tree traversal will not be the selected node in further tree traversals.

At step 524, the selected node is added to the seen list and the tree traversal is stopped. If this step is performed, it has been determined that the selected node is not the root node of a desired subgraph and a tree traversal will not be performed again on the selected node.

At step 526, the program determines if there are any nodes left in the category graph that are not part of the list of seen nodes or the list of roots of subgraphs. If there are nodes that are not part of the list of seen nodes or the list of roots of subgraphs, the process repeats steps 516 through 526 by selecting a node that is not in the list of seen nodes or the list of roots of subgraphs. If all the nodes in the category graph are part of either, or both, of the list of seen nodes or the list of roots of subgraphs, the process continues to step 528.

At step 528, the list of roots of subgraphs is sorted from high to low by how many nodes are reachable from a given root.

Once the subgraphs are derived, the additional step of finding the subgraph that contains both of the selected pair of categories is performed. If there is no subgraph that contains both categories within the selected pair of categories then the similarity is estimated to be low. When estimating the similarity to be low, the similarity between the selected pair of categories is considered to be 0.

Implementationally, the process for computing the similarity between categorized objects may be divided between pre-computation (offline) processing and on-demand computation (online) processing. Building the graph may be an offline process. Computing the other components of the main architecture may be done either online or offline. The choice of division of processing in an operational system, especially a large system, may be regulated by certain time-space tradeoffs.

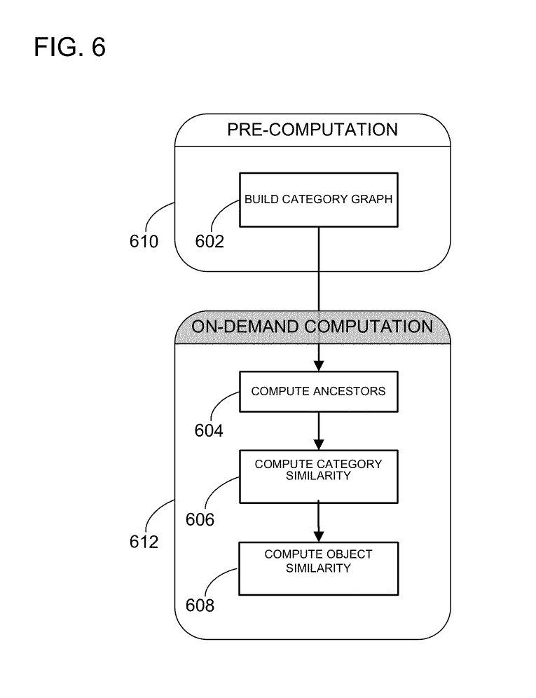

FIG. 6 shows an embodiment of the division between pre-computation and on-demand computation processing. Building the category graph 602 may be completed in the pre-computation processing 610. Computing the category ancestors 604, computing the category similarity matrix 606 and computing the object similarity 608 may be completed in the on-demand computation processing 612. This embodiment minimizes the memory footprint of the similarity computation by requiring a lot of on-demand computation. This embodiment not only increases response latencies, but also, when the category graph is sufficiently large, a real time computation of the similarity of objects is prohibitive.

In another embodiment, building the category graph 602 and computing the category ancestors 604 may be completed during pre-computation processing 610. Computing the category similarity matrix 606 and computing the object similarity 608 may be completed during on-demand computation processing 612. In computing the category ancestors 604 of this embodiment, a map that contains all the ancestors and their respective distances may be created for each category in the graph. This embodiment may require relatively more memory, but may increase the speed of the similarity computation.

In another embodiment, building the category graph 602, computing the category ancestors 604, and computing the category similarity matrix 606 may be completed during pre-computation processing 610. Computing the object similarity 608 may be completed during on-demand computation processing 612. Computing the category similarity 606 of two categories during pre-computation processing 610 may involve looking up the pre-computed similarity of the two categories.

In another embodiment, building the category graph 602, computing the category ancestors 604, computing the category similarity matrix 606, and computing the object similarity 608 may be completed during pre-computation processing 610. This may require the most amount of memory, but may reduce the latency.

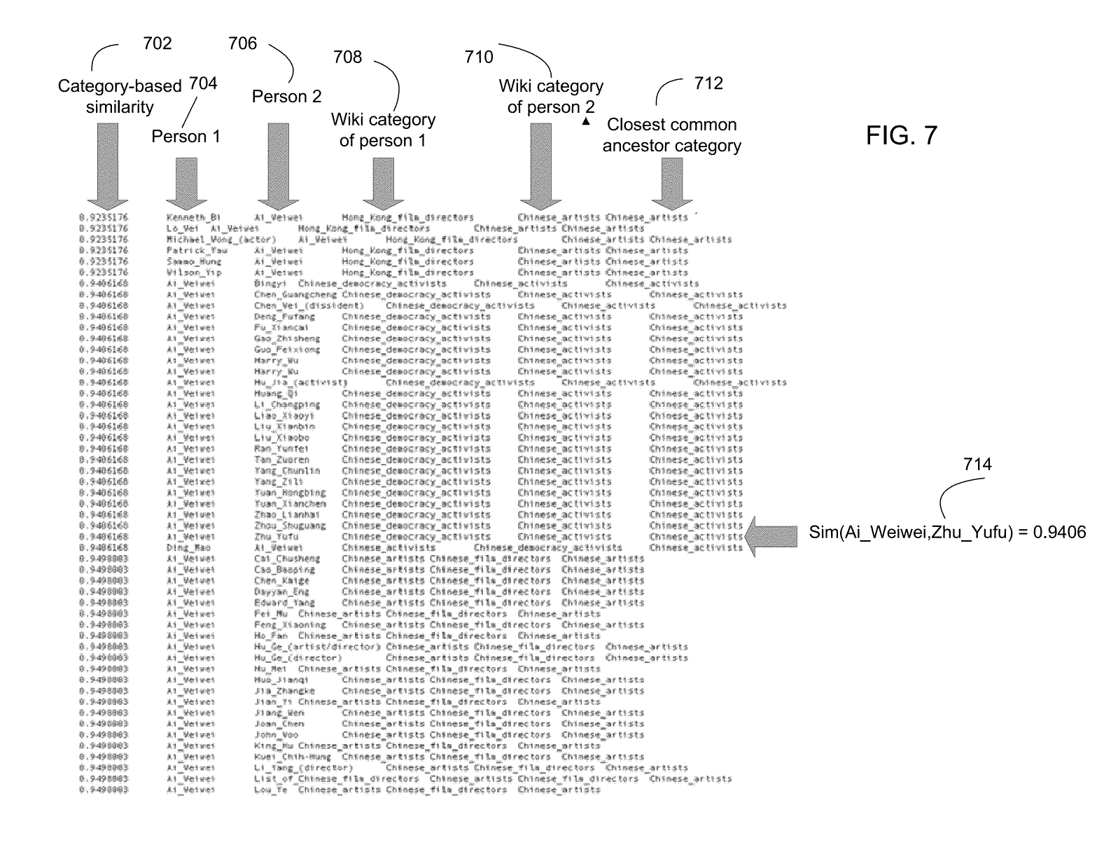

FIG. 7 shows a screen capture of results for an embodiment of the present invention. The calculated similarities are based on application of the embodiment of the present invention to open source encyclopedia Wikipedia. Objects in this case are Wikipedia pages of individual Chinese citizens. Each page also has one or more Wikipedia categories.

The columns person 1 704 and person 2 706 relate to a list of objects for which the similarity is being calculated, where the similarity is being calculated between two objects within the same row.

The columns Wiki category of person 1 708 and Wiki category of person 2 710 relate to the selection of a pair of categories which may be performed by step 204 of FIG. 2. Wiki category of person 1 708 and Wiki category of person 2 710 were produced through an external knowledge source search for the corresponding person 1 704 and person 2 706, respectively, within the same row.

The closest common ancestor category column 712 lists the closest common ancestor category for Wiki category of person 1 708 and Wiki category of person 2 710 within the same row. The closest common ancestor category may be determined through the exemplary flow diagram process of FIG. 3.

The category-based similarity column 702 lists the computed similarities between the Wiki category of person 1 708 and the Wiki category of person 2 710 within the same row. Category-based similarity 702 may be produced by step 212 of FIG. 2.

Sim(Ai_Weiwei,Zhu_Yufu) 714 shows the similarity metric for person 1 704 and person 2 706 of the row containing objects Ai Weiwei and Zhu Yufu. The similarity metric may be produced by step 214 of FIG. 2.

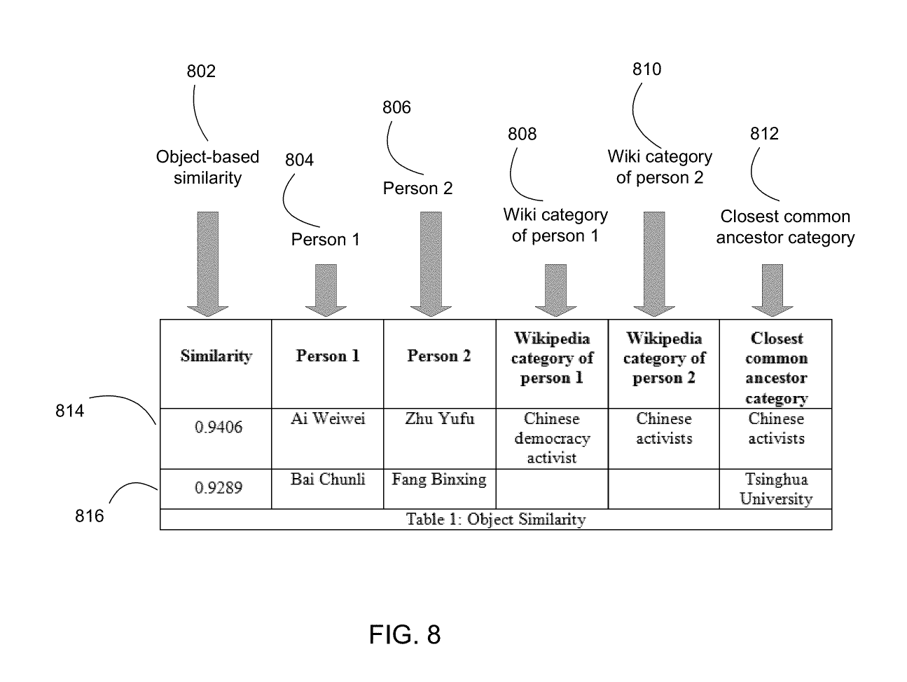

FIG. 8 shows, in table format, exemplary similarity calculation data and results for two pairs of objects. The two pairs of objects are four individual Chinese people who have a Wikipedia page. An individual's (or object's, in the nomenclature of our model) page belongs to one or more categories in Wikipedia. For example, a partial list of categories included in Ai Weiwei's Wikipedia page includes Chinese democracy activists, Charter 08 signatories, Artists from Beijing, Ai Weiwei, Weiquan movement, and Chinese anti-communists, among other categories.

The columns person 1 804 and person 2 806 relate to a list of objects for which the similarity is being calculated, where the similarity is being calculated between two objects within the same row.

The columns Wiki category of person 1 808 and Wiki category of person 2 810 relate to the selection of a pair of categories which may be performed by step 204 of FIG. 2. Wiki category of person 1 808 and Wiki category of person 2 810 were produced through an external knowledge source search for the corresponding person 1 804 and person 2 806, respectively, within the same row.

The closest common ancestor category column 812 lists the closest common ancestor category for Wiki category of person 1 808 and Wiki category of person 2 810 within the same row. The closest common ancestor category may be determined through the exemplary flow diagram process of FIG. 3.

The object-based similarity column 802 lists the computed similarities between the Wiki category of person 1 808 and the Wiki category of person 2 810 within the same row. Category-based similarity 802 may be produced by step 212 of FIG. 2.

Row 814 provides information related to the application of this embodiment of the invention to the objects Ai Weiwei and Zhu Yufu. The object-based similarity 802 of row 814 shows that Ai Weiwei and Zhu Yufu have strong similarity based on the similarity of one of Ai Weiwei's categories (“Chinese democracy activist”) and one of Zhu Yufu's categories (“Chinese activists”). These categories share “Chinese activists” as their closest common ancestor 812.

Row 816 provides information related to the application of this embodiment of the invention to the objects Bai Chunli and Fang Binxing. Similarly, Bai Chunli and Fang Binxing are highly similar, as displayed by the object-based similarity 802 of row 816, to one another because they share the category “Tsinghua University” as their closest common ancestor 812.

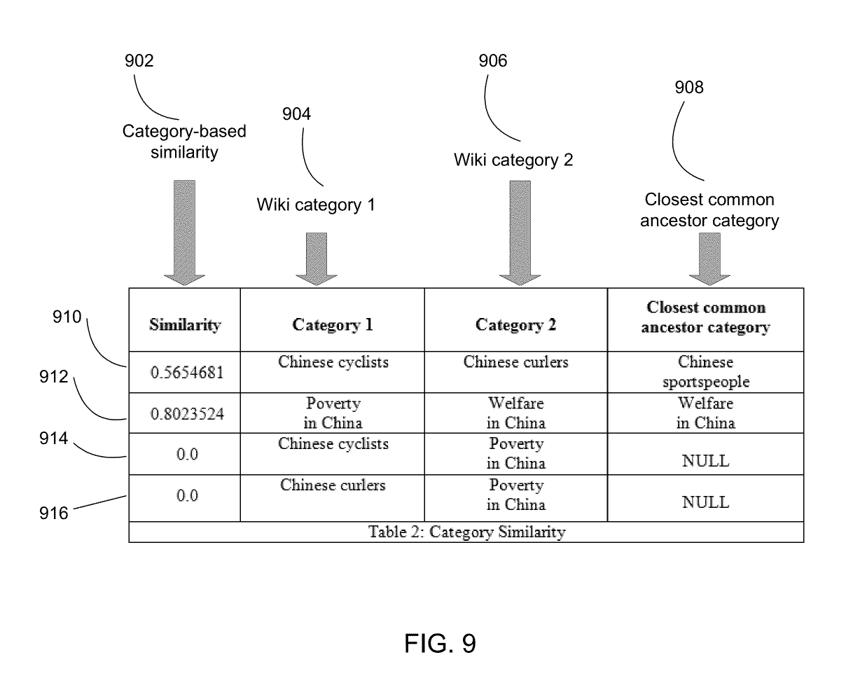

FIG. 9 shows, in table format, exemplary similarity calculation data and results for four pairs of categories given the subgraph “China” in Wikipedia category graph. The four pairs comprise four different subcategories of “China” category in Wikipedia: “Chinese cyclists”, “Chinese curlers”, “Poverty in China” and “Welfare in China.” FIG. 9 shows an embodiment of the invention as applied to a subgraph of Wikipedia (“China”). A subgraph as used in FIG. 9 may be produced by the process described by FIGS. 5A and 5B or may be the category graph originally built. The invention can operate on any part of the Wikipedia encyclopedia or any other categorical system, in general.

The columns Wiki category 1 904 and Wiki category 2 906 relate to the selection of a pair of categories which may be performed by step 204 of FIG. 2.

The closest common ancestor category column 908 lists the closest common ancestor category for Wiki category 1 904 and Wiki category 2 906 within the same row. The closest common ancestor category may be determined through the exemplary flow diagram process of FIG. 3.

The category-based similarity column 902 lists the computed similarities between the Wiki category 1 904 and the Wiki category 2 906 within the same row. Category-based similarity 902 may be produced by step 212 of FIG. 2.

Row 910 provides information related to the application of this embodiment of the invention to the categories “Chinese cyclists” and “Chinese curlers.” The category-based similarity 902 of row 910 shows that “Chinese cyclists” and “Chinese curlers” have a similarity of 0.5654681 based on the closest common ancestor category 908 of “Chinese sportspeople.”

Row 912 provides information related to the application of this embodiment of the invention to the categories “Poverty in China” and “Welfare in China.” The category-based similarity 902 of row 912 shows that “Poverty in China” and “Welfare in China” have a strong similarity based on the closest common ancestor category 908 of “Welfare in China.”

Row 914 provides information related to the application of this embodiment of the invention to the categories “Chinese cyclists” and “Poverty in China.” The category-based similarity 902 of row 914 shows that “Chinese cyclists” and “Poverty in China” have a low similarity as a closest common ancestor category 908 does not exist between the categories in the subgraph. Since a closest common ancestor category 908 does not exist between the categories in the subgraph, the category-based similarity 902 may be estimated to a similarity score of 0.0.

Row 916 provides information related to the application of this embodiment of the invention to the categories “Chinese curlers” and “Poverty in China.” The category-based similarity 902 of row 916 shows that “Chinese curlers” and “Poverty in China” have a low similarity as a closest common ancestor category 908 does not exist between the categories in the subgraph. Since a closest common ancestor category 908 does not exist between the categories in the subgraph, the category-based similarity 902 may be estimated to a similarity score of 0.0.

It will be obvious to those having skill in the art that many changes may be made to the details of the above-described embodiments without departing from the underlying principles of the invention. The scope of the present invention should, therefore, be determined only by the following claims.

1. A method comprising:
storing in a memory a category graph comprising a tree-based graphical data structure having plural parent and child category nodes connected by directed edges, such that sequences of connected category nodes represent hierarchical relations between categories of objects;
selecting a pair of categories of interest in the category graph;
in a processor, accessing the stored category graph and identifying ancestors of the selected pair of categories by traversing the category graph;
in a processor, comparing the ancestors of the selected pair of categories and identifying closest common ancestors;
in the processor, determining an information content corresponding to each of the selected pair of categories and the closest common ancestors; and
computing a similarity score for the selected pair of categories based on the closest common ancestors and the information content level.

2. The method of claim 1 further comprising, for each node, storing a count of a cumulative number of objects that are associated to a specific category.

3. The method of claim 1 wherein building the category graph includes transforming a directed cyclic graph to a directed acyclic graph to improve efficiency.

4. The method of claim 1, further comprising computing a similarity metric for a pair of objects based on the similarity score for the corresponding pair of categories.

5. The method of claim 4, further comprising building the category graph using backwards linked nodes, whereby a category node has a pointer to each of its parent nodes.

6. The method of claim 5 including:
building the category graph offline; and
executing the steps of identifying the ancestors, computing the similarity score of the selected pair of categories and computing the similarity metric on demand.

7. The method of claim 5 including:
building the category graph and identifying the ancestors offline; and
computing the similarity score of the selected pair of categories and computing the similarity metric on demand.

8. The method of claim 5 including:
building the category graph and identifying the ancestors and computing the similarity score of the selected pair of categories offline; and
computing the similarity metric on demand.

9. The method of claim 1 wherein:
identifying ancestors of the selected pair comprises, for each category of the pair, retrieving the corresponding ancestors by traversing the category graph upwards; and
the information content level is determined by counting a number of objects corresponding to each of the selected pair of categories and the closest common ancestors.

10. The method of claim 9 including storing the ancestors and respective distances in a map or dictionary data structure in a memory; and
where an ancestor occurs multiple times, storing only a minimum distance of the ancestor in the map or dictionary data structure.

11. The system of claim 10, including building the category graph by deriving the category graph as a subgraph from a parent graph, wherein the parent graph comprises equal or more categories than the category graph.

12. A system comprising:
a processor configured to:
store a category graph comprising a tree-based graphical data structure having plural parent and child category nodes connected by directed edges, such that sequences of connected category nodes represent hierarchical relations between categories of objects; and
a processor configured to:
access the stored category graph and identify ancestors of a selected pair of categories by traversing the category graph;
compare the ancestors of the selected pair of categories and identify closest common ancestors;
determine an information content corresponding to each of the selected pair of categories and the closest common ancestors; and
compute a similarity score for the selected pair of categories based on the closest common ancestors and the information content.

13. The system of claim 12, wherein the processor is further configured to compute a similarity metric for a pair of objects based on the similarity score for the corresponding pair of categories.

14. The system of claim 12, wherein identifying the ancestors of the selected pair comprises:
the processor being further configured to retrieve the corresponding ancestors by traversing the category graph upwards; and
the memory being further configured to store the distance at which the ancestors were found.

15. The system of claim 14, wherein the memory is further configured to:
store the ancestors and respective distances in a map or dictionary data structure; and
where an ancestor occurs multiple times, store only a minimum distance of the ancestor in the map or dictionary data structure.

16. A computer software product that includes a non-transitory storage medium readable by a processor, the medium having stored thereon a set of instructions for determining the similarity between a pair of categories, the instructions comprising:
storing in a memory a category graph comprising a tree-based graphical data structure having plural parent and child category nodes connected by directed edges, such that sequences of connected category nodes represent hierarchical relations between categories of objects;
selecting a pair of categories of interest in the category graph;
in a processor, accessing the stored category graph and identifying ancestors of the selected pair of categories by traversing the category graph;
in a processor, comparing the ancestors of the selected pair of categories and identifying closest common ancestors;
in the processor, determining an information content corresponding to each of the selected pair of categories and the closest common ancestors; and
computing a similarity score for the selected pair of categories based on the closest common ancestors and the information content.

17. The computer software product of claim 16, wherein the instructions further comprise computing a similarity metric for a pair of objects based on the similarity score for the corresponding pair of categories.

18. The computer software product of claim 16, wherein the instructions further comprise building the category graph by transforming a directed cyclic graph to a directed acyclic graph to improve efficiency.

19. The computer software product of claim 16, wherein the instructions further comprise storing the ancestors and respective distances in a map or dictionary data structure in a memory; and
wherein an ancestor occurs multiple times, storing only a minimum distance of the ancestor in the map or dictionary data structure.

20. The computer software product of claim 16, wherein the instructions further comprise storing a count of a cumulative number of objects that are associated to a specific category.
